(19) United States
(12) Patent Application Publication
(10) Pub. No.: US 2014/0030568 A1
(43) Pub. Date: Jan. 30, 2014

(54) CYLINDRICAL SECONDARY BATTERY

(71) Applicants: Yuki Hato, Hitachinaka (JP); Hideki Shinohara, Hitachinaka (JP); Takashi Sasaki, Hitachinaka (JP)

(72) Inventors: Yuki Hato, Hitachinaka (JP); Hideki Shinohara, Hitachinaka (JP); Takashi Sasaki, Hitachinaka (JP)

(73) Assignee: Hitachi Vehicle Energy, Ltd., Hitachinaka-shi, Ibaraki (JP)

(21) Appl. No.: 13/981,014

(22) PCT Filed: Jan. 31, 2012
(86) PCT No.: PCT/JP2012/052135

§ 371 Date: Oct. 7, 2013

(30) Foreign Application Priority Data
Jan. 31, 2011 (JP) 2011-017745

(51) Int. Cl. H01M 2/26; H01M 10/0587

(52) U.S. Cl. CPC H01M 2/263; H01M 10/0587
USPC 429/94

(57) ABSTRACT

The cylindrical secondary battery includes a plurality conductive leads, which are formed to be tapered from a root portion to a tip portion, and when a tolerance of a pitch of the conductive leads is Δp and a difference of width dimension between the root portion and the tip portion of the conductive leads is Δw, the pitch of the conductive leads is set to fall within a proper region where a variation range of a numerical value obtained by dividing a standard deviation of the number of layers of the conductive leads when the conductive leads are wound around a current collecting member by an average value of the standard deviations of the number of layers of the conductive leads is a predetermined value or less, and a range of the proper region is larger than the sum of Δp and Δw.

### TECHNICAL FIELD

The present invention relates to a cylindrical secondary battery, and more particularly, relates to a cylindrical secondary battery in which at least one of a positive electrode and a negative electrode is joined with a current collecting member.

### BACKGROUND ART

A cylindrical secondary battery as represented by a lithium secondary battery and the like is configured such that an electrode group formed by a positive electrode and a negative electrode being wound around a shaft core via a separator is housed in a battery container and an electrolyte is injected therein. The positive and negative electrodes respectively include positive and negative active materials coated on both sides of positive and negative metal foils. The positive and negative metal foils respectively include a large number of conductive leads arranged at a predetermined pitch along one side edge in a longitudinal direction.

The conductive leads of the positive and negative metal foils are respectively joined to electrode current collecting members by means of ultrasonic welding and the like while keeping the state where the conductive leads are respectively wound around outer peripheries of thin and cylindrical current collecting plates and a large number of conductive leads are layered each other.

The conductive leads formed on the positive and negative metal foils are arranged at even intervals, usually, about several ten mm. Since the metal foil has the length of several thousand mm, the conductive lead is wound around the outer periphery of the electrode current collecting member several ten turns. The wound conductive lead shifts its position by each turn. Therefore, the number of layers is different depending on the position on the electrode current collecting member. That is, the number of layered conductive leads varies.

As described above, the conductive lead is welded to the electrode current collecting member. A portion where the number of layered conductive leads is large, large energy is required in joining. In contrast, a portion where the number of layered conductive leads is small, energy required for joining can be small. Since the energy in joining is constant, if the number of layers of the conductive leads widely varies, the joining state such as joining force widely varies.

Therefore, internal resistances of the conductive lead and the electrode current collecting member and the like widely vary, and the battery characteristics are impaired.

In response to the above problem, a structure is known, in which the pitch of the conductive leads formed on the metal foil wound around the electrode current collecting member is changed to be gradually larger in proportion to the distance of the metal foil in the longitudinal direction, and only the conductive leads having a predetermined angle are layered while keeping the state of being wound around the electrode current collecting member (see PTL 1).

### CITATION LIST

### Patent Literature

PTL 1: Japanese Patent Application Laid-Open No. 11-111259

### SUMMARY OF INVENTION

### Technical Problem

However, as disclosed in PTL 1, forming the pitch of the conductive leads formed on the metal foil to be gradually larger in proportion to the distance of the metal foil in the longitudinal direction makes the manufacturing method complicated, resulting in low productivity. In addition, a variation of torque occurs in winding the conductive leads. Therefore, a reduction in yield is expected.

### Solution to Problem

A cylindrical secondary battery according to a first aspect of the present invention includes: an electrode group formed by a positive electrode and a negative electrode being wound via a separator, the positive electrode being formed such that a positive electrode mixture is formed on both sides of a positive metal foil in which a large number of conductive leads are formed at a predetermined pitch along one side edge in a longitudinal direction, and the negative electrode being formed such that a negative electrode mixture is formed on both sides of a negative metal foil in which a large number of conductive leads are formed at a predetermined pitch along the other side edge facing the one side edge where the conductive leads of the positive electrode are formed; a current collecting member formed by the conductive leads of at least one of the positive electrode and the negative electrode being wound, layered, and joined; and a battery container housing the electrode group and the current collecting member, and to which an electrolyte is injected, wherein the conductive leads are formed to be tapered from a root portion to a tip portion, and when a tolerance of a pitch of the conductive leads is Δp and a difference of width dimension between the root portion and the tip portion of the conductive leads is Δw, the pitch of the conductive leads is set to fall within a proper region where a variation range of a numerical value obtained by dividing a standard deviation of the number of layers of the conductive leads when the conductive leads are wound around the current collecting member by an average value of the standard deviations of the number of layers of the conductive leads is a predetermined value or less, and a range of the proper region is larger than a sum of Δp and Δw.

In a second aspect of the present invention, it is preferable that, in the cylindrical secondary battery according to the first aspect, the pitch of the conductive leads is set to fall within the proper region where the range is 2 mm or more, and the variation range of a numerical value is 0.2 or less.

In a third aspect of the present invention, in the cylindrical secondary battery according to the first aspect, the pitch of the conductive leads may be set to fall within the proper region where the range is 2 mm or more, and the variation range of a numerical value is 0.1 or less.

In a fourth aspect of the present invention, it is preferable that, in the cylindrical secondary battery according to any of the first to third aspects, the separator includes a first separator and a second separator, and the following expression is satisfied:

3.4341+0.00266972x+37.6812y<p<−1.75694+0.0032418x+63.7681y

where the pitch of the conductive leads is p mm, a length of the positive electrode or the negative electrode corresponding to the conductive leads joined to the current collecting member is x mm, and an electrode repetition thickness that is a total thickness of the positive electrode, the negative electrode, and the first and second separators is y mm.

In a fifth aspect of the present invention, in the cylindrical secondary battery according to any of the first to third aspects, the separator includes a first separator and a second separator, and the following expression may be satisfied:

2.76142+0.0032418x+55.0725y<p<2.30873+0.00411899x+68.1159y

where the pitch of the conductive leads is p mm, a length of the positive electrode or the negative electrode corresponding to the conductive leads joined to the current collecting member is x mm, and an electrode repetition thickness that is a total thickness of the positive electrode, the negative electrode, and the first and second separators is y mm.

In a sixth aspect of the present invention, in the cylindrical secondary battery according to any of the first to third aspects, the separator includes a first separator and a second separator, and the following expression may be satisfied:

3.65859+0.00495805x+62.3188y<p<−11.1444+0.00781846x+143.478y

where the pitch of the conductive leads is p mm, a length of the positive electrode or the negative electrode corresponding to the conductive leads joined to the current collecting member is x mm, and an electrode repetition thickness that is a total thickness of the positive electrode, the negative electrode, and the first and second separators is y mm.

In a seventh aspect of the present invention, it is preferable that, in the cylindrical secondary battery according to any of the first to sixth aspects, the conductive leads are conductive leads of the positive electrode and conductive leads of the negative electrode.

### Advantageous Effects of Invention

According to the cylindrical secondary battery of the invention, the variation of the number of layers of the conductive leads can be sufficiently reduced, and the variation of the joining state can be reduced.

### BRIEF DESCRIPTION OF DRAWINGS

FIG. 1 is a cross sectional view of a cylindrical secondary battery according to an embodiment of the present invention.

FIG. 2 is an exploded perspective view of the cylindrical secondary battery illustrated in FIG. 1.

FIG. 3 is a perspective view illustrating an electrode group of FIG. 1 in detail, in which a part thereof is cut off.

FIG. 4 is a plan view illustrating positive/negative electrodes of the electrode group illustrated in FIG. 3, in which a separator is partially developed.

FIG. 5 is an enlarged cross sectional view around a positive lead of the cylindrical secondary battery of FIG. 1.

FIG. 6 is a graph illustrating the number of layers of conductive leads layered on an outer periphery of a current collecting member with respect to a circumferential angle.

FIG. 7 is a graph illustrating a distribution of the number of layers of the conductive leads.

FIG. 8 is a graph illustrating a deviation of the number of layers of conductive leads with respect to a pitch of the conductive lead.

FIG. 9 is a table related to a range of the conductive lead pitch and the number of layers in each proper region illustrated in FIG. 8.

FIG. 10 is a graph illustrating a relationship between the width of the conductive leads and the pitch of the conductive leads in regions A, B, and C illustrated in FIG. 8.

FIG. 11 is a graph illustrating a relationship between an outer diameter of the current collecting member and the pitch of the conductive leads in the regions A, B, and C illustrated in FIG. 8.

FIG. 12 is a graph illustrating a relationship between the length of an electrode and the pitch of the conductive leads in the regions A, B, and C illustrated in FIG. 8.

FIG. 13 is a graph illustrating a relationship between an electrode repetition thickness and the pitch of the conductive leads in the regions A, B, and C illustrated in FIG. 8.

FIG. 14 is a graph illustrating a relationship among the length of an electrode, the electrode repetition thickness, and the pitch of the conductive leads in the regions A, B, and C illustrated in FIG. 8.

### DESCRIPTION OF EMBODIMENTS

Hereinafter, a cylindrical secondary battery of the present invention will be described with reference to the drawings.

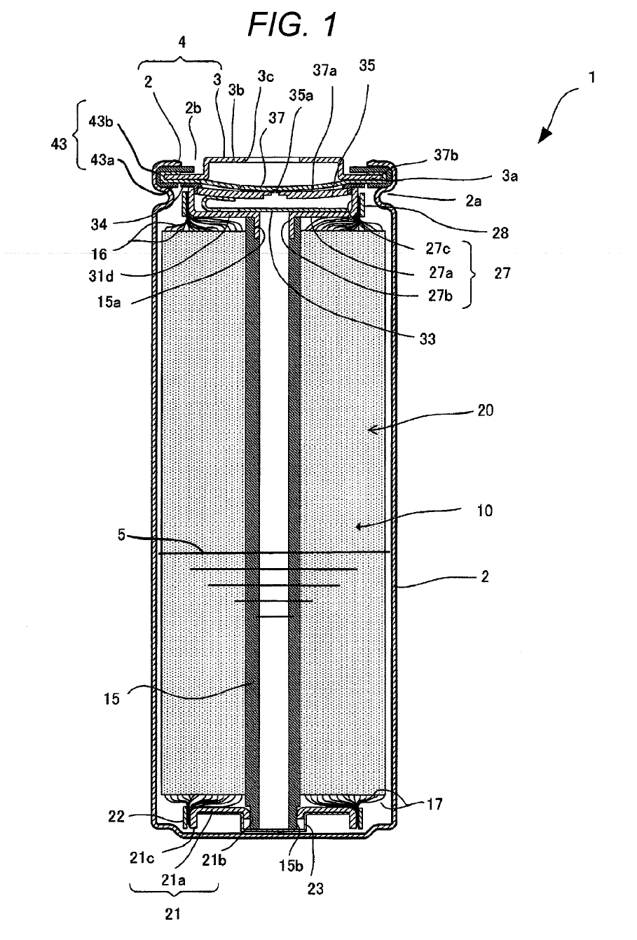

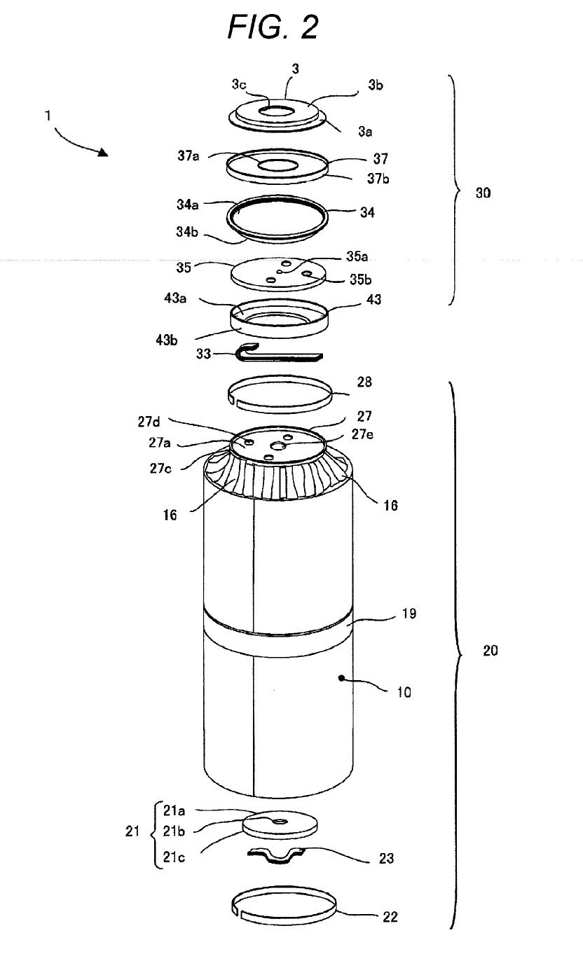

FIG. 1 is an enlarged cross sectional view of a cylindrical secondary battery according to an embodiment of the present invention, and FIG. 2 is an exploded perspective view of the cylindrical secondary battery illustrated in FIG. 1.

A cylindrical secondary battery 1 is, for example, lithium ion secondary battery, and has dimensions of the outer diameter of 40 mmφ, and the height of 100 mm. The cylindrical secondary battery 1 includes a battery container 4 formed of an open-top closed-bottom cylindrical battery can 2 having a bottom portion and an open upper portion, and a hat-shaped battery lid 3 that seals the upper portion of the battery can 2. Constitutive members for power generation to be herewith described are housed in an interior of the battery container 4, and a non-aqueous electrolyte 5 is injected therein.

An inwardly protruding groove 2a is formed on a side of an opening portion 2b provided on an upper end side in the open-top closed-bottom cylindrical battery can 2.

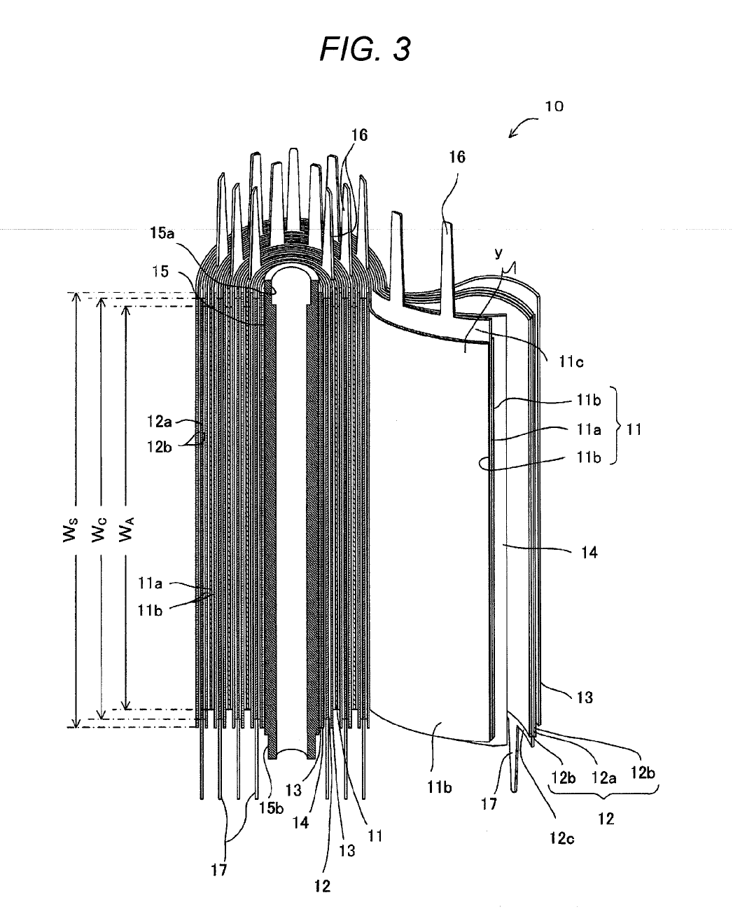

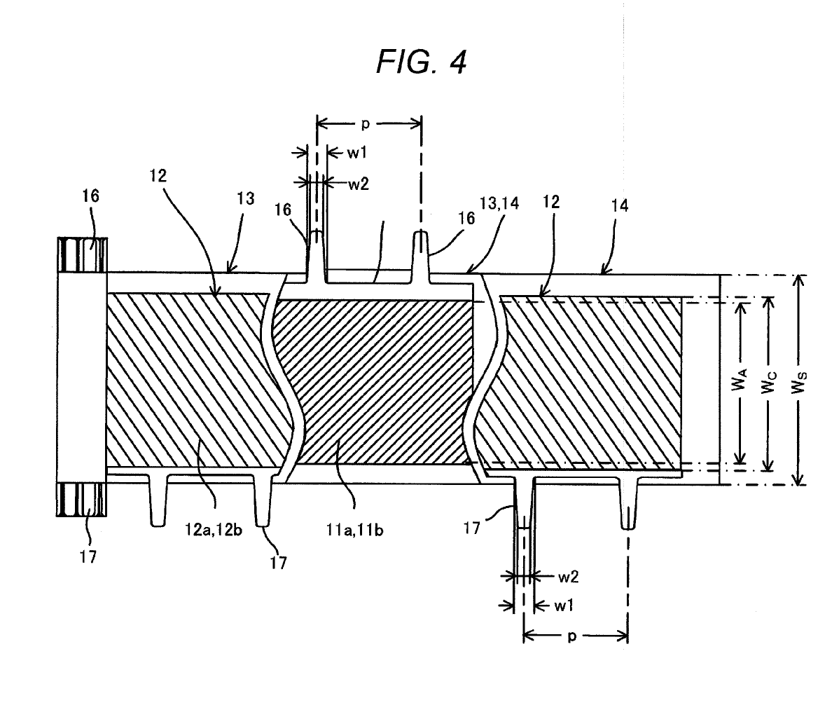

An electrode group 10 is arranged in a central portion of the battery can 2. The electrode group 10 is provided with a long and narrow cylindrical shaft core 15 having a hollow portion along a shaft direction, and a positive electrode and a negative electrode wound around the shaft core 15. FIG. 3 is a perspective view illustrating a detailed structure of the electrode group 10, a part of which has been cut off. FIG. 4 is a plan view of the positive/negative electrodes and a separator of the electrode group illustrated in FIG. 3, a part of which has been developed.

As illustrated in FIG. 3, the electrode group 10 has a structure in which a positive electrode 11, a negative electrode 12, and first and second separators 13 and 14 are wound around the shaft core 15.

The shaft core 15 has a hollow cylindrical shape including a hollow portion formed along the shaft. The negative electrode 12, the first separator 13, the positive electrode 11, and the second separator 14 are layered in this order and are wound around the shaft core 15. The first separator 13 and the second separator 14 are wound several times (one turn in FIG. 3) inside the negative electrode 12 positioned at the innermost periphery. The first separator 13 and the second separator 14 are formed of an insulating porous body. Further, the negative electrode 12 and the first separator 13 wound around the outer periphery of the negative electrode 12 are positioned at the outermost periphery side. The first separator 13 at the outermost periphery is taped with adhesive tape 19 (see FIG. 2).

The positive electrode 11 is made of a long aluminum foil, and includes a positive metal foil 11a and a positive electrode processing portion 11b obtained by a positive electrode mixture being applied on both sides of the positive metal foil 11a. A side edge of an upper side of FIG. 3 extending in the longitudinal direction of the positive metal foil 11a is a positive electrode mixture unprocessing portion 11c where the positive electrode mixture is not applied and the aluminum foil is exposed. A large number of positive leads 16 upwardly protruding along the shaft of the shaft core 15 are integrally formed on the positive electrode mixture unprocessing portion 11c at even intervals.

The positive electrode mixture is made of a positive electrode active material, a positive electrode conductive material, and a positive electrode binder. The positive electrode active material is favorably, lithium metal oxide or lithium transition metal oxide. Examples thereof include lithium cobalt oxide, lithium manganese oxide, lithium nickel oxide, and lithium composite metal oxide (including lithium transition metal oxide including two or more selected from cobalt, nickel, and manganese). The positive electrode conductive material is not particularly limited, provided that it is a substance that can assist transmission of electrons to the positive electrode, the electrons being generated by an occlusion reaction of lithium in the positive electrode mixture. Note that the above-described lithium composite metal oxide including transition metal has conductivity. Therefore, the lithium composite metal oxide itself may be used as the positive electrode conductive material. However, above all, a favorable characteristic can be obtained by using lithium composite oxide made of the above-described materials containing lithium cobalt oxide, lithium manganese oxide, and lithium nickel oxide.

The positive electrode binder is capable of binding the positive electrode active material and the positive electrode conductive material, and is also capable of binding the positive electrode mixture and a positive current collecting body. The positive electrode binder is not particularly limited, provided that it is not substantially deteriorated by contact with the non-aqueous electrolyte 5. Examples of the positive electrode binder include polyvinylidene fluoride (PVDF) and fluorine rubber. A method of forming the positive electrode processing portion 11b with the positive electrode mixture is not particularly limited, provided that it is a method by which the positive electrode mixture can be formed on the positive metal foil 11a. An example of the method of forming the positive electrode processing portion 11b with the positive electrode mixture includes a method of applying a dispersion solution of constitutive substances of the positive electrode mixture on the positive metal foil 11a.

Examples of a method of applying a positive electrode mixture to the positive metal foil 11a include a roll coating method and a slit dye coating method. N-methylpyrrolidone (NMP) and water, as an example of a solvent for the dispersion solution, are added to the positive electrode mixture, mixed and kneaded slurry is uniformly applied on the both surfaces of an aluminum foil having the thickness of 20 and is pressed and cut after dried. The thickness of application of the positive electrode mixture is, for example, about 40 μm on each side. In cutting the positive metal foil 11a by a press, the positive leads 16 are integrally formed. All of the positive leads 16 have almost the same length.

The negative electrode 12 is made of a long copper foil, and includes a negative metal foil 12a and a negative electrode processing portion 12b obtained by a negative electrode mixture being applied to both sides of the negative metal foil 12a. A side edge at a lower side of FIG. 3 extending in the longitudinal direction of the negative metal foil 12a is a negative electrode mixture unprocessing portion 12c where the negative electrode mixture is not applied and the copper foil is exposed. A large number of negative leads 17 extending in the opposite direction to the positive leads 16 along the shaft of the shaft core 15 are integrally formed in the negative electrode mixture unprocessing portion 12c at even intervals.

The negative electrode mixture includes a negative electrode active material, a negative electrode binder, and a thickener. The negative electrode mixture may include a negative electrode conductive material such as acetylene black. It is favorable to use graphite carbon, especially, to use artificial graphite as the negative electrode active material. By using graphite carbon, a lithium ion secondary battery for a plug-in type hybrid automobile or an electric automobile that requires a high capacity can be manufactured. The method of forming the negative electrode processing portion 12b with the negative electrode mixture is not particularly limited, provided that it is a method by which the negative electrode mixture can be formed on the negative metal foil 12a. An example of the method of applying the negative electrode mixture to the negative metal foil 12a includes a method of applying a dispersion solution of constitutive substances of the negative electrode mixture on the negative metal foil 12a. Examples of the applying method include a roll coating method and a slit dye coating method.

As an example of the method of applying the negative electrode mixture to the negative metal foil 12a, N-methyl-2-pyrrolidone and water, as a dispersion solvent, are added to the negative electrode mixture, mixed and kneaded slurry is uniformly applied on the both surfaces of a rolled copper foil having the thickness of 10 μm, and is pressed and cut after dried. The thickness of the application of the negative electrode mixture is, for example, about 40 μm on each side. When the negative metal foil 12a is cut by a press, the negative leads 17 are also integrally formed. All of the negative leads 17 have almost the same length.

The first separator 13, the second separator 14, the negative electrode processing portion 12h, and the positive electrode processing portion 11b are formed to satisfy the following expression:

W_{S}>W_{C}>W_{A} (see FIG. 3)

where the width of the first separator 13 and the second separator 14 is W_{S}, the width of the negative electrode processing portion 12b formed on the negative metal foil 12a is W_{C}, and the width of the positive electrode processing portion 11b formed on the positive metal foil 11a is W_{A}.

That is, the width W_{C} of the negative electrode processing portion 12b is always larger than the width W_{A} of the positive electrode processing portion 11b. This is because, in the case of a lithium ion secondary battery, although lithium that is the positive electrode active material is ionized and infiltrates the separator, if the negative electrode active material is not formed on the negative metal foil 12a side and the negative metal foil 12a is exposed with respect to the positive electrode processing portion 11b, the lithium is deposited on the negative metal foil 12a, and this may be a cause of occurrence of internal short circuit.

The positive leads (conductive lead) 16 formed on the positive electrode mixture unprocessing portion 11c of the positive metal foil 11a and the negative leads (conductive lead) 17 formed on the negative electrode mixture unprocessing portion 12c of the negative metal foil 12a are formed at even intervals at a predetermined pitch p by a roll cutter, for example, as illustrated in FIG. 4.

The positive leads 16 and the negative leads 17 have a tapered shape in which the width w1 of a root portion is wide and the width w2 of a tip portion is narrow. For example, the width w1 of the root portion is about 5 mm, the width w2 of the tip portion is about 4 mm, and a difference Δw between the width w1 of the root portion and the width w2 of the tip portion is about 1 mm.

The width w1 of the root portion and the width w2 of the tip portion of the positive leads 16 and of the negative leads 17 may be the same, or may be different. As to be described below, the width of the positive leads 16 and the negative leads 17 have no substantial influence on a variation of the number of layers of the conductive leads.

The first separator 13 and the second separator 14 are respectively formed of polyethylene porous membranes having the thickness of 40 μm, for example.

In FIGS. 1 and 3, a, groove (step portion) 15a having a larger diameter than a hollow portion is formed in an inner surface of an upper end portion of the hollow cylindrical shaft core 15 in the shaft direction (in an up and down direction in the drawing), and a positive current collecting member 27 having a thin and approximately cylindrical shape is pressed into the step portion 15a. The positive current collecting member 27 is formed of, for example, aluminum, and includes a disk-shaped base portion 27a, a lower cylinder portion 27b protruding toward the shaft core 15 side from an inner periphery of the base portion 27a and being pressed in an inner surface of the step portion 15a of the shaft core 15, and an upper cylinder portion 27c protruding toward the battery lid 3 side from an outer peripheral edge. An opening portion 27d for releasing a gas generated inside the battery (see FIG. 2) is formed in the base portion 27a of the positive current collecting member 27.

All of the positive leads 16 of the positive metal foil 11a are welded to the upper cylinder portion 27c of the positive current collecting member 27. As illustrated in FIG. 2, the positive leads 16 are layered on the upper cylinder portion 27c of the positive current collecting member 27 and joined. Since each of the positive leads 16 is very thin, one positive lead alone cannot take out a large current. Therefore, a large number of positive leads 16 are formed at a predetermined interval throughout the entire length from the start of winding to the shaft core 15 of the positive metal foil 11a to the end of winding.

Since the positive current collecting member 27 is oxidized by an electrolyte, the positive current collecting member 27 can improve the reliability by being formed of aluminum. When a surface of aluminum is exposed by some way of processing, an aluminum oxide film is immediately formed on the surface, and oxidation due to an electrolyte can be prevented by this aluminum oxide film.

In addition, by forming the positive current collecting member 27 with aluminum, the positive leads 16 of the positive metal foil 11a can be welded to the positive current collecting member 27 by means of ultrasonic welding, spot welding, and the like.

The positive leads 16 of the positive metal foil 11a and a pressure member 28 are welded to an outer periphery of the upper cylinder portion 27c of the positive current collecting member 27. The large number of positive leads 16 are stuck to the outer periphery of the upper cylinder portion 27c of the positive current collecting member 27, the pressure member 28 is wound around an outer periphery of the positive leads 16 in a ring-shaped manner and temporarily fixed, and the positive leads 16 and the pressure member 28 are welded under this state.

A step portion 15b having a smaller outer diameter than the outer diameter of the shaft core 15 is formed at the outer periphery of a lower end portion of the shaft core 15, and a negative current collecting member 21 is pressed into the step portion 15b and is fixed. The negative current collecting member 21 is, for example, formed of copper, and an opening portion 21b pressed into the step portion 15b of the shaft core 15 is formed in the disk-shaped base portion 21a, and an outer peripheral cylinder portion 21c protruding toward the bottom portion side of the battery can 2 is formed at an outer peripheral edge.

All of the negative leads 17 of the negative metal foil 12a are welded to the outer peripheral cylinder portion 21c of the negative current collecting member 21 by means of ultrasonic welding, and the like. Since each of the negative leads 17 is very thin, the large number of negative leads 17 are formed throughout the entire length from the start of winding to the shaft core 15 of the negative metal foil 12a to the end of winding at a predetermined interval, in order to take out a large current.

The negative leads 17 of the negative metal foil 12a and a pressure member 22 are welded to the outer periphery of the outer peripheral cylinder portion 21c of the negative current collecting member 21. The large number of negative leads 17 are stuck to the outer periphery of the outer peripheral cylinder portion 21c of the negative current collecting member 21, the pressure member 22 is wound around an outer periphery of the negative leads 17 in a ring-shaped manner and temporarily fixed, and the negative leads 17 and the pressure member 22 are welded under this state.

A negative electrode conducting lead 23 made of nickel is welded to a lower surface of the negative current collecting member 21.

The negative electrode conducting lead 23 is welded to the iron battery can 2 at the bottom portion thereof.

Here, an opening portion 27e formed in the positive current collecting member 27 is used for insertion of an electrode bar (not illustrated) that is used to weld the negative electrode conducting lead 23 to the battery can 2. An electrode bar is inserted to the hollow portion of the shaft core 15 from the opening portion 27e formed in the positive current collecting member 27, and the negative electrode conducting lead 23 is pressed to an inner surface of the bottom portion of the battery can 2 by a tip portion of the electrode bar, so that resistance welding is performed. The bottom surface of the battery can 2 connected to the negative current collecting member 21 functions as one output terminal of the cylindrical secondary battery 1, and is capable of taking electric power stored in the electrode group 10 out of the battery can 2.

The large number of positive leads 16 are welded to the positive current collecting member 27, and the large number of negative leads 17 are welded to the negative current collecting member 21, so that a power generating unit 20 in which the positive current collecting member 27, the negative current collecting member 21, and the electrode group 10 are integrally unitized is constructed (see FIG. 2). Note that, in FIG. 2, for convenience of illustration, the negative current collecting member 21, the pressure member 22, and the negative electrode conducting lead 23 are separated from the power generating unit 20 and illustrated.

A flexible connecting member 33 constructed by a plurality of aluminum foils being layered is joined by means of welding such that one end portion thereof is welded to an upper surface of the base portion 27a of the positive current collecting member 27. The connecting member 33 can flow a large current by a plurality of layers of aluminum foils being layered and integrated, and has flexibility. That is, to flow a large current, it is necessary to increase the thickness of the connecting member 33. If one sheet of metal plate is used to form the connecting member 33, the rigidity is increased, and the flexibility is deteriorated. Therefore, the large number of aluminum foils having a small plate thickness are layered to have the flexibility. The thickness of the connecting member 33 is about 0.5 mm, for example, and five sheets of aluminum foils having the thickness of 0.1 mm each are layered to form the connecting member 33.

A battery lid unit 30 is arranged on the upper cylinder portion 27c of the positive current collecting member 27. The battery lid unit 30 includes a ring-shaped insulating plate 34, a connecting plate 35 inserted to an opening portion 34a provided in the insulating plate 34, a diaphragm 37 welded to the connecting plate 35, and the battery lid 3 fixed to the diaphragm 37 by swaging.

The insulating plate 34 is made of an insulating resin material having the circular opening portion 34a and has a ring shape, and is placed on the upper cylinder portion 27c of the positive current collecting member 27.

The insulating plate 34 includes an opening portion 34a (see FIG. 2) and a side portion 34b protruding downward. The connecting plate 35 is fit in the opening portion 34a of the insulating plate 34. The other end portion of the connecting member 33 is welded and joined to a lower surface of the connecting plate 35. In this case, the connecting member 33 is bent at the other end portion side in a curved manner, and the surface welded to the positive current collecting member 27 is also welded to the connecting plate 35.

The connecting plate 35 is formed of an aluminum alloy, and almost entire part except the central portion is uniform and has an approximately plate-like shape in which a center part is slightly bent to a lower position. The thickness of the connecting plate 35 is, for example, about 1 mm. In the center of the connecting plate 35, a thin-walled, dome-shaped protrusion portion 35a is formed, and around the protrusion portion 35a, a plurality of opening portions 35b (see FIG. 2) is formed. The opening portions 35b have a function to release a gas generated inside the battery.

The protrusion portion 35a of the connecting plate 35 is joined to the bottom surface of the central portion of the diaphragm 37 by means of resistance welding or friction stir welding. The diaphragm 37 is formed of an aluminum alloy, and includes a circular notch 37a formed around the central portion of the diaphragm 37. The notch 37a is formed such that the upper surface is pressed into a V shape by a press, and a remained portion is formed into a thin wall. The diaphragm 37 is provided to secure safety of the battery. When an internal pressure of the battery is increased, as the first stage, the diaphragm 37 warps upwardly, breaks up the joint with the protrusion portion 35a of the connecting plate 35 and is separated from the connecting plate 35, and cuts the conductivity with the connecting plate 35. As the second stage, if the internal pressure still rises, the diaphragm 37 is cleaved at the notch 37a, and has a function to release the internal gas.

The diaphragm 37 fixes a fringe portion 3a of the battery lid 3 at a fringe portion. The diaphragm 37 initially includes a side wall 37b at the fringe portion, which vertically rises toward the battery lid 3 side, as illustrated in FIG. 2. The battery lid 3 is housed in the side wall 37b and the side wall 37b is bent toward the upper surface side of the battery lid 3 by swaging, and is fixed.

The battery lid 3 is formed of iron such as carbon steel and is subjected to nickel plating, and has a hat shape including a disk-shaped fringe portion 3a that is in contact with the diaphragm 37 and an top-closed bottom-open cylinder portion 3b upwardly protruding from the fringe portion 3a. An opening portion 3c is formed in the cylinder portion 3b. This opening portion 3c is used to release a gas outside the battery when the diaphragm 37 is cleaved by gas pressure that occurs inside the battery. The battery lid 3 functions as the other electric power output terminal of the cylindrical secondary battery 1, and is capable of taking the stored electric power out of the battery lid 3.

Note that, in the case where the battery lid 3 is formed of iron, the battery can be joined with another cylindrical secondary battery which is formed of iron by means of spot welding when joined with the another cylindrical secondary battery in series.

A gasket (seal member) 43 is provided to cover the fringe portion of the side wall 37b of the diaphragm 37. The gasket 43 is formed of rubber, and an example of a favorable material includes fluororesin although there is no intention of limiting the invention.

The gasket 43 has, initially, a shape including an outer peripheral wall portion 43b that almost vertically rises on a peripheral side edge of the ring-shaped base portion 43a in an upward direction, as illustrated in FIG. 2.

Then, the periphery wall portion 43b of the gasket 43 is bent along with the battery can 2 by a press and the like, and the diaphragm 37 and the battery lid 3 are subjected to swaging processing so as to be pressed in the shaft direction by the base portion 43a and the periphery wall portion 43b. Accordingly, the battery lid unit 30 in which the battery lid 3, the diaphragm 37, the insulating plate 34, and the connecting plate 35 are integrally formed is fixed to the battery can 2 via the gasket 43.

The non-aqueous electrolyte 5 is injected into an interior of the battery can 2 by a predetermined quantity. As an example of the non-aqueous electrolyte 5, a solution prepared by a lithium salt dissolved in a carbonate type solvent is favorably used. Examples of lithium salts include lithium hexafluorophosphate (LiPF₆) and lithium tetrafluoroborate (LiBF₆). Moreover, examples of carbonate type solvents include ethylene carbonate (EC), dimethyl carbonate (DMC), propylene carbonate (PC), methyl-ethyl carbonate (MEC), and mixtures of two or more solvents selected from the above.

As described above, all of the large number of positive leads 16 formed on the positive electrode 11 are welded to the outer periphery of the upper cylinder portion 27c of the positive current collecting member 27 by means of ultrasonic welding, and the like. In this case, the positive leads 16 are almost evenly allocated and stuck throughout the entire circumference of the outer periphery of the upper cylinder portion 27c of the positive current collecting member 27, and the pressure member 28 is wound around an outer periphery of the positive leads 16. More properly, a pressure member 28 is held in a flat manner, and the positive current collecting member 27, to which the positive leads 16 are wound, is rotated with sticking to the positive leads 16 while the positive leads 16 and the pressure member 28 are welded to the positive current collecting member 27 by means of ultrasonic welding, and the like.

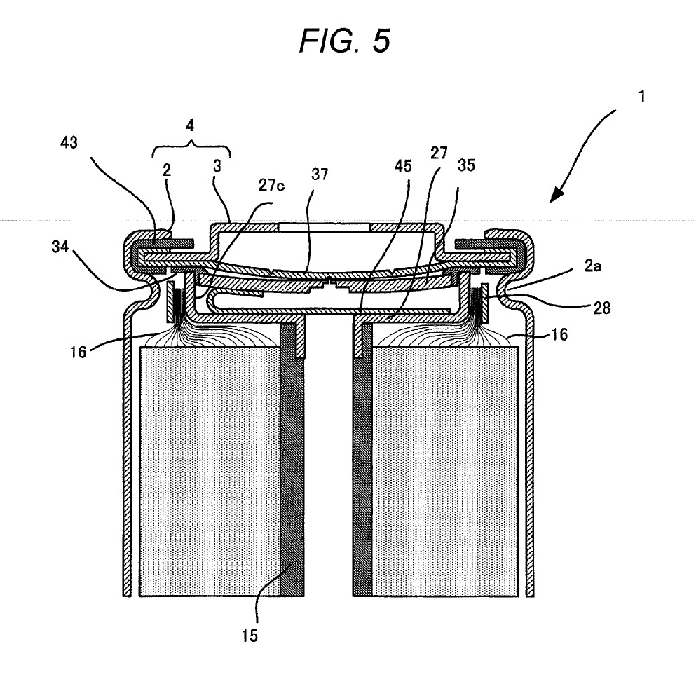

A method of welding the negative leads 17 to the negative current collecting member 21 is performed in a similar manner to the positive electrode side. FIG. 5 is an enlarged cross sectional view of the cylindrical secondary battery 1 around the positive leads 16.

The positive leads 16 are formed at even intervals, for example, at a pitch of 20 to 60 mm. The positive metal foil 11a has the length of 3000 to 5000 mm in the longitudinal direction, for example, and the positive leads 16 are wound around the outer surface of the upper cylinder portion 27c of the positive current collecting member 27 several ten times.

The positive electrode 11 is wound around the outer periphery of the shaft core 15, and the thickness of the electrode group is increased by each turn. That is, the thickness is increased by the total thickness of the positive electrode 11, the negative electrode 12, the first separator 13, and the second separator 14 (electrode repetition thickness) by each turn.

Therefore, the positive lead 16 arranged at a given pitch p is joined to the upper cylinder portion 27c of the positive current collecting member 27 at a different circumferential angle position by each turn. Due to the above, the number of layers of the positive leads 16 joined to the positive current collecting member 27 varies with respect to the circumferential angle. This also applies to the negative electrode side, and the negative leads 17 are joined to the outer peripheral cylinder portion 21c of the negative current collecting member by a different number of layers depending on the circumferential angle position.

Hereinafter, a variation of the number of layers of the positive leads 16 (hereinafter, referred to as conductive leads 16) will be described a representative example of the positive leads 16 and the negative leads 17.

### (Cause of Layers of Conductive Leads)

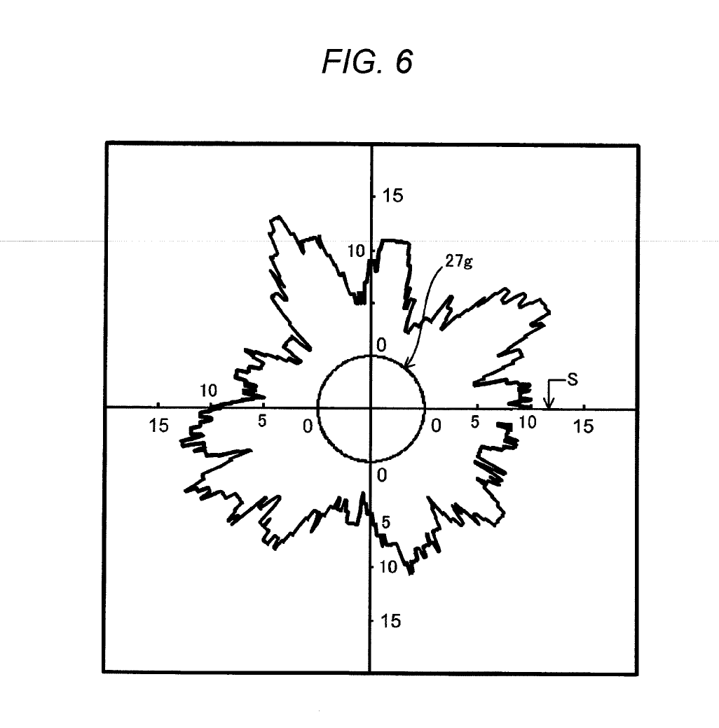

FIG. 6 is a graph illustrating the number of layers of the conductive leads 16 formed on the positive metal foil 11a and wound around the outer periphery of the upper cylinder portion 27c of the positive current collecting member 27. FIG. 6 illustrates the number of layers of the conductive leads 16 is increased in proportion to the distance in a radial direction based on the outer peripheral surface 27g of the upper cylinder portion 27c of the positive current collecting member 27, which is counted as 0 (zero) layer. This drawing illustrates the number of layers of the conductive leads 16 at an interval of 0.5° circumferential angle from the start position S of winding the conductive leads 16 in the outer peripheral surface 27g of the upper cylinder portion 27c of the positive current collecting member 27.

In FIG. 6, the minimum number of layers of the conductive leads 16 is about 5 layers, and the maximum number of layers of the conductive leads 16 is about 15 layers. Between the minimum and maximum numbers of layers, the number of layers of the conductive leads 16 is illustrated by each 0.5° circumferential angle.

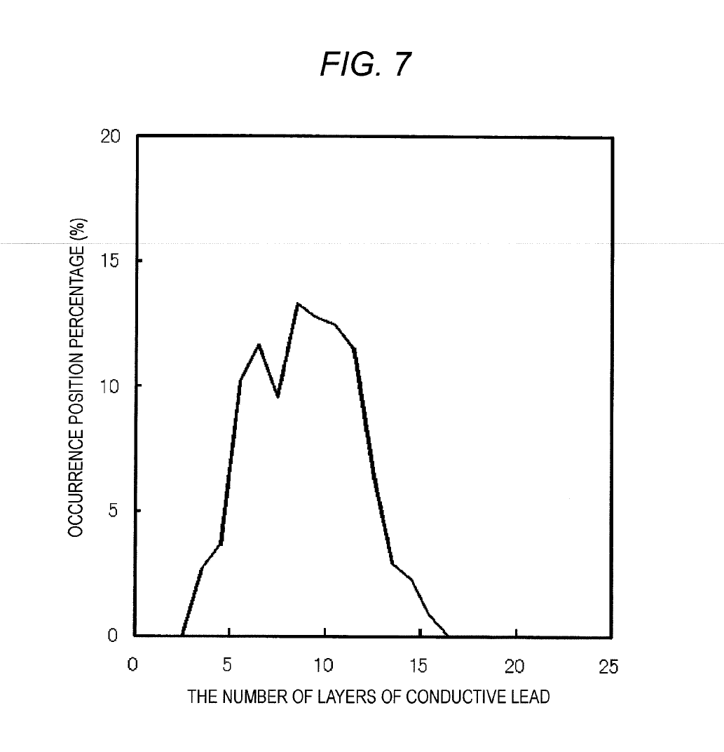

FIG. 7 is a graph illustrating the number of layers of each circumferential angle position illustrated in FIG. 6 by a distribution of a percentage of occurrence (percentage of occurrence position) of each number of layers.

Data illustrated in FIG. 7 can be used when a standard deviation of the number of layers of the conductive leads 16 is obtained.

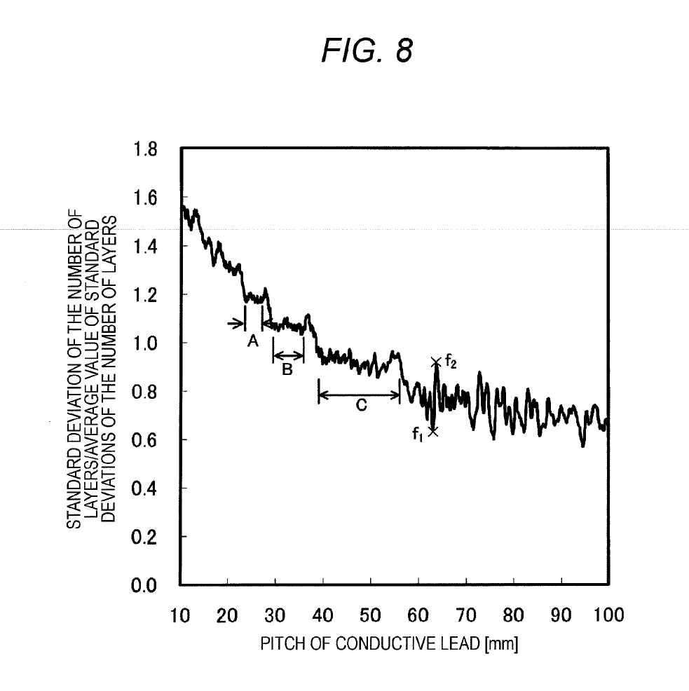

FIG. 8 illustrates a graph of the variation of the standard deviation of the number of layers of the conductive leads 16 formed by changing the pitch p by 0.1 mm within the range of 10 to 100 mm. The number of layers is obtained by calculation where the width of the conductive leads 16 is 5 mm, the outer diameter of the upper cylinder portion 27c of the positive current collecting member 27 is 30 mm, the repetition thickness y (see FIG. 3) of the electrode, that is, the total thickness of the positive electrode 11, the negative electrode 12, the first separator 13, and the second separator 14 is 0.25 mm, and the length of the positive electrode 11 is 4000 mm. The horizontal axis of FIG. 8 represents the pitch p of the conductive leads 16, and the vertical axis represents a numerical value obtained by dividing the standard deviation of the number of layers of the conductive leads 16 by an average value of the standard deviations of the number of layers of the conductive leads 16. The standard deviation of the number of layers of the conductive leads 16 can be obtained from the distribution of the percentage of occurrence position of the number of layers of each circumferential angle position illustrated in FIG. 7 with regard to the number of layers of the conductive leads 16 when the conductive lads 16 formed at a given pitch p are wound. The pitch p is changed by 0.1 mm in the range of 10 to 100 mm, and the standard deviation of the number of layers of the conductive leads 16 is calculated for each pitch p. The average of the standard deviations of the number of layers of the conductive leads 16 is an average of the standard deviations of the number of layers of the conductive leads 16 formed by different pitches p, that is, an average of a plurality of standard deviations of different pitches p. Hereinafter, for simplification of description, the definition of the vertical axis: “a numerical value obtained by dividing the standard deviation of the number of layers of the conductive leads by an average of the standard deviations of the number of layers of the conductive leads” is simply referred to as “a relative value of a deviation of the number of layers of the conductive leads”.

In FIG. 8, the vertical axis, that is, the relative value of the deviation of the number of layers of the conductive leads 16 being small means that the energy required in welding such as ultrasonic welding is near a given value. Therefore, it is more favorable than a case where the relative value of the deviation of the number of layers of the conductive leads 16 is large. FIG. 8 indicates a tendency that the larger the pitch of the conductive leads 16, the smaller the relative value of the deviation of the number of layers of the conductive leads. This is because the number of conductive leads 16 wound around the current collecting member is decreased as the pitch of the conductive leads 16 is increased, which is one cause.

However, the most important thing is that a variation range of a relative value of the number of layers of the conductive leads is small in a wide range of the pitches of the conductive leads 16, that is, a region of pitch where the variation range becomes small is wide. Hereinafter, the above matter will be described.

There are two causes in manufacturing, which has influence on the number of layers of the conductive leads 16.

The first cause is a tolerance of the pitch p of the conductive leads 16. The position of the conductive leads 16 varies by the tolerance of the pitch p of the conductive leads 16 in manufacturing, which influences the number of layers of the conductive leads 16.

The second cause is the shape of the conductive leads 16. As described above, the conductive leads 16 has a tapered shape in which the width w1 of the root portion is large, and the width w2 of the tip portion is small. The conductive leads 16 is wound around the shaft core 15, and the distance from the root portion of the conductive leads 16 to the positive current collecting member 27 or to the negative current collecting member 21 from the inner periphery to the outer periphery is changed. Therefore, there are two cases where the root portion of the conductive leads 16 is joined to the positive current collecting member 27 or the negative current collecting member 21 and where the tip portion of the conductive leads 16 is joined to the positive current collecting member 27 or the negative current collecting member 21, and the width of the conductive leads 16 in welding is changed in each case. Therefore, the number of layers of the conductive leads 16 varies depending on the cases.

The position of the conductive leads 16 varies by (Δp+Δw) where the tolerance of the pitch p of the conductive leads 16 is Δp, and the difference between the width w1 of the root portion and the width w2 of the tip portion of the conductive leads 16 is Δw=(w1−w2).

That is, in FIG. 8, for example, the relative value f₁ of the deviation of the number of layers of the conductive leads 16 when the pitch p of the conductive leads 16 is about 60 mm, is about 0.7, which is a small value. However, the relative value f₂ of the variation of the number of layers of the conductive leads when the pitch p of the conductive leads 16 is about 61 mm, is about 0.9, which is a sharp increase.

This means that, in a region of the pitch p where the relative value of the deviation of the number of layers of the conductive layer widely varies when the pitch p of the conductive leads 16 is slightly changed, the number of layers of the conductive leads 16 widely varies due to the variation in manufacturing.

That is, to reduce the variation change of the number of layers of the conductive leads 16 and to uniform the joining force when the conductive leads 16 are welded to the positive current collecting member 27 or to the negative current collecting member 21, it is important to determine the pitch p of the conductive leads 16 to fall within the region where the variation range of the relative value of the deviation of the number of layers of the conductive leads 16 is small in a wide range of the pitch p of the conductive leads 16.

Applying an actual manufacturing condition, the tolerance Δp in manufacturing, which is the first cause, when the conductive leads 16 are formed is 1 mm (±0.5 mm). The difference Δw between the width w1 of the root portion and the width w2 of the tip portion of the conductive leads 16, which is the second cause, is about 1 mm, as described above.

Therefore, in actual manufacturing, the position of the conductive leads 16 may be shifted by about (Δp+Δw)=2 mm.

In FIG. 8, the regions A, B, and C are within a range of the pitch p of the conductive leads 16, that is, a range between an upper limit value and a lower limit value of the pitch in the region, is 2 mm or more, and the variation range of the relative value of the deviation of the number of layers of the conductive leads in the regions is 0.2 or less. These regions have smaller variation ranges of the relative value of the number of layers of the conductive lead than other regions where the range of the pitch p of the conductive leads 16 is 2 mm or more.

In this way, when the pitch p of the conductive leads 16 falls within the regions A, B, and C, even if the position of the conductive leads 16 is shifted in manufacturing, the number of layers of the conductive leads 16 does not widely vary. Therefore, if the pitch p of the conductive leads 16 is determined within the range of the regions A, B, and C, the variation range of the number of layers of the conductive leads 16 can be made small. As a result, highly uniformed joining between the conductive leads 16 and the positive current collecting member 27 or the negative current collecting member 21 can be realized. With the highly uniform joining, the cylindrical secondary battery 1 having excellent battery characteristics such as fewer variations of the internal resistance can be manufactured.

Note that, in FIG. 8, in a region between the regions A and B, the range of the pitch p of the conductive leads 16 is 2 mm or more, and the variation range of the relative value of the deviation of the number of layers of the conductive leads is 0.2 or less. Therefore, the pitch p of the conductive leads 16 may be determined from the ranges of this region. However, this region has a narrower range of the pitch p of the conductive leads 16 and a larger variation range of the relative value of the deviation of the number of layers of the conductive leads than the regions A, B, and C. Therefore, it is more desirable to set the pitch p of the conductive leads 16 from the ranges of the regions A, B, and C. Hereinafter, the regions A, B, and C are referred to as proper regions.

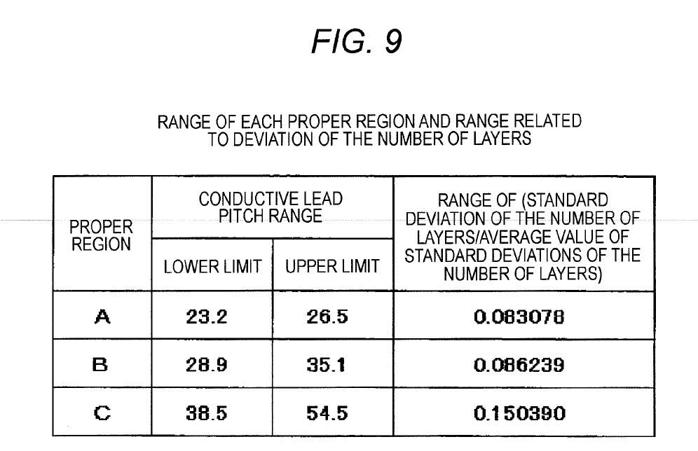

FIG. 9 is a table illustrating a lower limit value and an upper limit value of the pitch of the conductive leads 16 in each proper regions A, B, and C illustrated in FIG. 8 and a value of a range of (the standard deviation of the number of layers of the conductive leads/the average value of the standard deviations of the number of layers of the conductive leads).

In the ranges of the proper regions A, B, and C, the variation ranges of the number of layers of the conductive leads 16 are small, and a favorable cylindrical secondary battery 1 can be obtained. However, if the pitch p of the conductive leads 16 becomes large, the number of conductive leads 16 joined to the positive current collecting member 27 or the negative current collecting member 21 is decreased and the internal resistance is increased. In this sense, it is more desirable to determine the pitch p of the conductive leads 16 within the proper region A or B than within the proper region C.

In this case, although to be described below, since the width w1 of the root portion of the conductive leads 16 has no influence on the variation of the number of layers of the conductive leads 16, the width w1 of the root portion of the conductive leads 16 may be made large when the pitch p of the conductive leads 16 is made large.

However, making the width of the conductive leads 16 large means a joining portion of the conductive leads 16 and the cylindrical positive current collecting member 27 or the negative current collecting member 21 becomes wide. The joining portion of the conductive leads 16 is formed into an arc shape in the track of the outer periphery of the cylindrical positive current collecting member 27 or negative current collecting member 21. Therefore, if the width of the joining portion of the conductive leads 16 becomes large, the joining portion is largely deformed with respect to a portion at the root side of the conductive leads 16, which is not joined, and the conductive leads 16 are subject to breakage. Therefore, it is necessary to determine the width dimension of the conductive leads 16 in consideration of the above matter.

### (Parameters of the Number of Layers of Conductive Leads)

Next, parameters that have influence on the number of layers of the conductive leads 16 will be described.

There are four parameters that have influence on the number of layers of the conductive leads 16 other than the pitch p of the conductive leads 16, as follows:

(i) The width of the conductive lead
(ii) The outer diameter of the current collecting member (in the case of the positive lead, the outer diameter of the positive current collecting member, and in the case of the negative lead, the outer diameter of the negative current collecting member)
(iii) The electrode length (in the case of the positive lead, the length of the positive electrode, and in the cause of the negative lead, the length of the negative electrode)
(iv) Electrode repetition thickness

Hereinafter, the relationship between each parameter and the number of layers of the conductive leads 16 will be described in order.

### (Width of Conductive Lead)

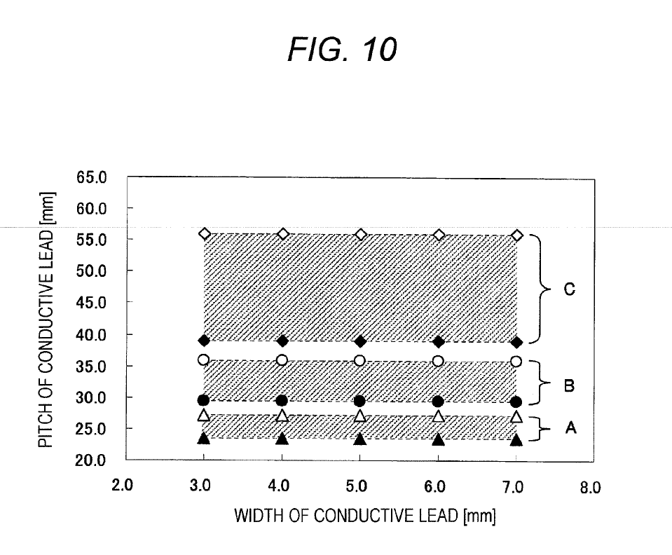

FIG. 10 is a graph illustrating a relationship between the width of the conductive leads and the pitch of the conductive leads in the proper regions A, B, and C illustrated in FIG. 8.

Similarly to the case of FIG. 8, how the standard deviation of the number of layers of the conductive leads varies when the pitch p of the conductive leads 16 is changed by 0.1 mm is obtained by calculation with respect to the width of the conductive leads 16 in the range of 3.0 to 7.0 mm. That is, graphs of FIG. 8 are created with respect to the widths of the conductive leads 16 of 3.0, 4.0, 5.0, 6.0, and 7.0 mm, respectively, and in each graph, the pitches p of the conductive leads 16 that are the ranges of the regions A, B, and C of FIG. 8 are plotted. As for the parameters other than the width of the conductive leads 16, the outer diameter of the positive/negative current collecting members 27 and 21 is 30 mm, the electrode length (not illustrated) is 4000 mm, and the electrode repetition thickness y is 0.25 mm.

In FIG. 10, there are fewer differences among the proper regions A, B, and C where the variation ranges of the deviation of the number of layers are small according to the variation of the width of the conductive leads 16. That is, it can be seen that the widths of the conductive leads 16 do not influence the variation of the deviation of the number of layers of the conductive leads 16.

### (Outer Diameter of Current Collecting Member)

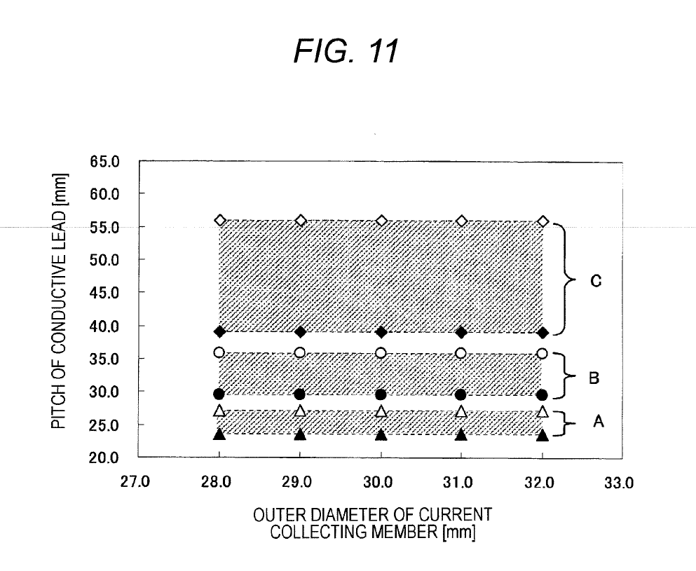

FIG. 11 is a graph illustrating a relationship between the outer diameter of the positive/negative current collecting member 27 and 21 and the pitch of the conductive leads in the proper regions A, B, and C illustrated in FIG. 8.

Similarly to the case of FIG. 8, how the standard deviation of the number of layers of the conductive leads varies when the pitch p of the conductive leads 16 is changed by 0.1 mm is obtained by calculation with respect to the positive/negative current collecting members 27 and 21 in the range of 28.0 to 32.0 mm. That is, graphs of FIG. 8 are created with respect to the outer diameters of the current collecting members 27 and 21 of 28.0, 29.0, 30.0, 31.0, and 32.0 mm, respectively, and in each graph, the pitches p of the conductive leads 16 that are the ranges of the regions A, B, and C of FIG. 8 are plotted. As for the parameters other than the outer diameter of the positive/negative current collecting members 27 and 21, the width of the conductive leads 16 is 5 mm, the electrode length (not illustrated) is 4000 mm, and the electrode repetition thickness y is 0.25 mm.

In FIG. 11, even if the outer diameter of the positive/negative current collecting members 27 and 21 is changed, there are fewer differences among the proper regions A, B, and C where the variation ranges of the deviation of the number of layers are small. That is, it can be seen that the outer diameters of the positive/negative current collecting members 27 and 21 do not influence the variation of the deviation of the number of layers of the conductive leads 16.

### (Electrode Length)

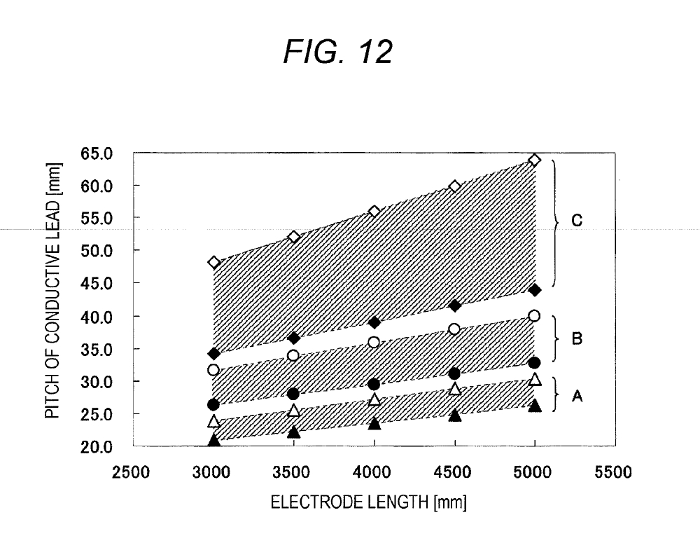

FIG. 12 is a graph illustrating a relationship between the length of an electrode in the longitudinal direction (not illustrated) and the pitch of the conductive leads in the proper regions A, B, C illustrated in FIG. 8.

Similarly to the case of FIG. 8, how the standard deviation of the number of layers of the conductive leads varies when the pitch p of the conductive leads 16 is changed by 0.1 mm is obtained by calculation with respect to the electrode length in the range of 3000 to 5000 mm. That is, graphs of FIG. 8 are created with respect to the electrode lengths of 3000, 3500, 4000, 4500, and 5000 mm, respectively, and in each graph, the pitches p of the conductive leads 16 that are the ranges of the regions A, B, and C of FIG. 8 are plotted. As for the parameters other than the electrode length, the width of the conductive leads 16 is 5 mm, the outer diameter of the positive/negative current collecting members 27 and 21 are 30 mm, and the electrode repetition thickness y is 0.25 mm.

In FIG. 12, the proper regions A, B, and C where the variation ranges of the deviation of the number of layers are changed according to the variation of the electrode length. That is, the electrode length is a parameter that has influence on the variation of the deviation of the number of layers of the conductive leads 16.

### (Electrode Repetition Thickness)

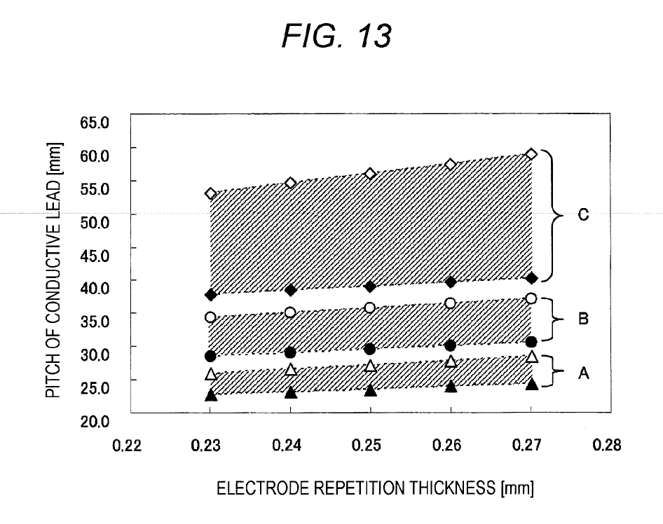

FIG. 13 is a graph illustrating a relationship between the electrode repetition thickness y and the pitch of the conductive leads in the proper regions A, B, and C of FIG. 8.

As described above, the electrode repetition thickness y (see FIG. 3) is the total thickness of the positive electrode 11, the negative electrode 12, the first separator 13, and the second separator 14.

Similarly to the case of FIG. 8, how the standard deviation of the number of layers of the conductive leads varies when the pitch p of the conductive leads 16 is changed by 0.1 mm is obtained by calculation with respect to the electrode repetition thickness y in the range of 0.23 to 0.27 mm. That is, graphs of FIG. 8 are created with respect to the electrode repetition thickness of 0.23, 0.24, 0.25, 0.26, and 0.27 mm, respectively, and in each graph, the pitches p of the conductive leads 16 that are the ranges of the regions A, B, and C of FIG. 8 are plotted. As for the parameters other than the electrode repetition thickness y, the width of the conductive leads 16 is 5 mm, the outer diameter of the positive/negative current collecting members 27 and 21 is 30 mm, and the electrode length is 4000 mm.

In FIG. 13, the proper regions A, B, and C where the variation ranges of the deviation of the number of layers is changed according to the variation of the electrode repetition thickness y. That is, the electrode repetition thickness y is a parameter that has influence on the variation of the deviation of the number of layers of the conductive leads 16.

As a result of the above, it can be seen that the proper regions A, B, and C where the variation ranges of the deviation of the number of layers of the conductive leads 16 is small are not influenced by the changes of the width of the conductive leads 16 and of the outer diameter of the positive/negative current collecting members 27 and 21, but vary by the electrode length and the electrode repetition thickness y.

In addition, according to FIGS. 12 and 13, the variation of the proper regions A, B, and C can be linearly approximated by the changes of the electrode length and of the electrode repetition thickness y.

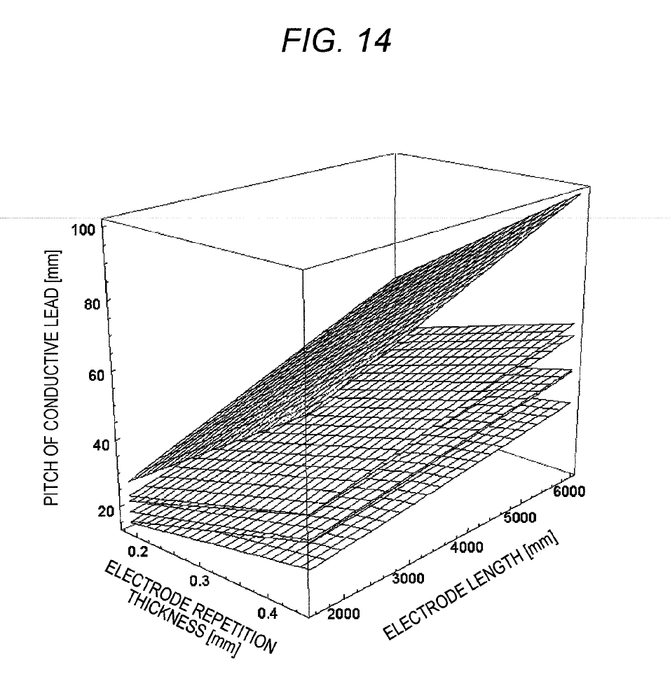

FIG. 14 is a graph illustrating a relationship between the electrode length, the electrode repetition thickness, and the pitch of the conductive leads in the proper regions of A, B, and C illustrated in FIG. 8.

As illustrated in FIG. 14, the proper regions A, B, and C where the variation ranges of the deviation of the number of layers of the conductive leads 16 is small can be limited by the plane configured from the three parameters of the pitch p of the conductive leads 16, the electrode length, and the electrode repetition thickness y.

When the cylindrical secondary battery 1 is manufactured, the pitch p of the conductive leads 16 is determined to fall within the range of the proper regions A, B, and C where the variation ranges of the deviation of the number of layers of the conductive leads 16 is small, with functions of the electrode length and the electrode repetition thickness y. Accordingly, the variation of the deviation of the number of layers of the pitch p of the conductive leads 16 can be suppressed.

The functions with respect to the proper regions A, B, and C are as follows:

(1) Proper region A:

3.4341+0.00266972x+37.6812y<p<−1.75694+0.0032418x+63.7681y

(2) Proper region B:

2.76142+0.0032418x+55.0725y<p<2.30873+0.00411899x+68.1159y

(3) Proper region C:

3.65859+0.00495805x+62.3188y<p<−11.1444+0.00781846x+143.478y

where the length of the electrode to which the intended conductive leads 16 are provided is x mm, the electrode repetition thickness is y mm, and the pitch of the conductive leads 16 is p.

As described above, in the above embodiment, the pitch of the conductive leads is set to fall within the range where the variation range of the numerical value obtained by dividing the standard deviation of the number of layers of the conductive leads by the average value of the standard deviations of the number of layers of the conductive leads is the predetermined value or less, where the tolerance of the pitch of the conductive lead is Δp, and the difference of the depth dimension between the root portion and the tip portion of the conductive leads is Δw. The range is larger than the sum of Δp and Δw. With such a configuration, the variation of the number of layers of the conductive leads can be sufficiently reduced. Accordingly, the conductive leads can be uniformly welded to the outer periphery of the current collecting member. Therefore, the cylindrical secondary battery 1 having excellent battery characteristics such as fewer variations of the internal resistance can be manufactured. In this case, since the pitch p of the conductive leads 16 is provided at even intervals, the positive electrode 11, the negative electrode 12, and the electrode group 10 can also be efficiently manufactured. Note that the predetermined value of the variation range is, for example, 0.2, as described above. Note that the predetermined value of the variation range may be a value other than 0.2, for example, may be 0.1.

Note that, in the above-described embodiment, an example of applying the present invention to a lithium ion cylindrical secondary battery has been described. However, the present invention can be applied to a cylindrical secondary battery using a water-soluble electrolyte, such as nickel-metal hydride battery, nickel-cadmium battery, and lead storage battery.

Further, while the above-described embodiment has been described where the tolerance Δp of the conductive leads 16 is 1 mm and the difference Δw between the width w1 of the root portion and the width w2 of the tip portion of the conductive leads 16 is 1 mm, the present invention can be applied to second batteries using electrode units respectively having different values of Δp and Δw.

In the above-described embodiment, the electrode group 10 has a structure where the first and second separators 13 and 14 lie between the positive electrode 11 and the negative electrode 12. However, a structure may be employed in which the first and second separators 13 and 14 are configured from one single separator, and the separator separates the positive electrode 11 and the negative electrode 12. Further, the pitches p of the both of the positive leads 16 and the negative leads 17 may be set as described above, or the pitch p of one of the positive leads 16 and the negative leads 17 may be set as described above. In addition, the cylindrical secondary battery of the present invention can be modified and applied within the scope of the gist of the present invention. In other words, any cylindrical secondary battery may be favorable, provided that the cylindrical secondary battery includes: an electrode group formed by a positive electrode and a negative electrode being wound via a separator, the positive electrode being formed such that a positive electrode mixture is formed on both sides of a positive metal foil in which a large number of conductive leads are formed at a predetermined pitch along one side edge in a longitudinal direction, and the negative electrode being formed such that a negative electrode mixture is formed on both sides of a negative metal foil in which a large number of conductive leads are formed at a predetermined pitch along the other side edge facing the one side edge where the conductive leads of the positive electrode are formed; current collecting member formed by a conductive leads of at least one of the positive electrode and the negative electrode being wound, layered, and joined; and a battery container housing the electrode group and the current collecting member, and to which an electrolyte is injected, wherein the conductive leads is formed to be tapered from a root portion to a tip portion; and when a tolerance of a pitch of the conductive leads is Δp and a difference of width dimension between the root portion and the tip portion of the conductive leads is Δw, the pitch of the conductive leads is set to fall within a proper region where a variation range of a numerical value obtained by dividing a standard deviation of the number of layers of the conductive leads when the conductive leads is wound around the current collecting member by an average value of the standard deviations of the number of layers of the conductive leads is a predetermined value or less; and a range of the proper region is larger than a sum of Δp and Δw.

While various embodiments and modifications have been described above, the present invention is not limited by these contents. Other aspects that can be considered within the scope of the technical idea of the present invention are also included in the scope of the present invention.

The disclosure of the following priority application is herein incorporated by reference:

Japanese Patent Application No. 2011-017745 (filed on Jan. 31, 2011)

1. A cylindrical secondary battery comprising:
an electrode group formed by a positive electrode and a negative electrode being wound via a separator, the positive electrode being formed such that a positive electrode mixture is formed on both sides of a positive metal foil in which a large number of conductive leads are formed at a predetermined pitch along one side edge in a longitudinal direction, and the negative electrode being formed such that a negative electrode mixture is formed on both sides of a negative metal foil in which a large number of conductive leads are formed at a predetermined pitch along the other side edge facing the one side edge where the conductive leads of the positive electrode are formed;
a current collecting member formed by the conductive leads of at least one of the positive electrode and the negative electrode being wound, layered, and joined; and
a battery container housing the electrode group and the current collecting member, and to which an electrolyte is injected,
wherein the conductive leads are formed to be tapered from a root portion to a tip portion, and
when a tolerance of a pitch of the conductive leads is Δp and a difference of width dimension between the root portion and the tip portion of the conductive leads is Δw, the pitch of the conductive leads is set to fall within a proper region where a variation range of a numerical value obtained by dividing a standard deviation of the number of layers of the conductive leads when the conductive leads are wound around the current collecting member by an average value of the standard deviations of the number of layers of the conductive leads is a predetermined value or less, and
a range of the proper region is larger than a sum of Δp and Δw.

2. The cylindrical secondary battery according to claim 1, wherein the pitch of the conductive leads is set to fall within the proper region where the range is 2 mm or more, and the variation range of a numerical value is 0.2 or less.

3. The cylindrical secondary battery according to claim 1, wherein the pitch of the conductive leads is set to fall within the proper region where the range is 2 mm or more, and the variation range of a numerical value is 0.1 or less.

4. The cylindrical secondary battery according to claim 1,
wherein the separator includes a first separator and a second separator, and the following expression is satisfied:
3.4341+0.00266972x+37.6812y<p<−1.75694+0.0032418x+63.7681y
where the pitch of the conductive leads is p mm, a length of the positive electrode or the negative electrode corresponding to the conductive leads joined to the current collecting member is x mm, and an electrode repetition thickness that is a total thickness of the positive electrode, the negative electrode, and the first and second separators is y mm.

5. The cylindrical secondary battery according to claim 1,
wherein the separator includes a first separator and a second separator, and the following expression is satisfied:
2.76142+0.0032418x+55.0725y<p<2.30873+0.00411899x+68.1159y
where the pitch of the conductive leads is p mm, a length of the positive electrode or the negative electrode corresponding to the conductive leads joined to the current collecting member is x mm, and an electrode repetition thickness that is a total thickness of the positive electrode, the negative electrode, and the first and second separators is y mm.

6. The cylindrical secondary battery according to claim 1,
wherein the separator includes a first separator and a second separator, and the following expression is satisfied:
where the pitch of the conductive leads is p mm, a length of the positive electrode or the negative electrode corresponding to the conductive leads joined to the current collecting member is x mm, and an electrode repetition thickness that is a total thickness of the positive electrode, the negative electrode, and the first and second separators is y mm.

7. The cylindrical secondary battery according to claim 1, wherein the conductive leads are conductive leads of the positive electrode and conductive leads of the negative electrode.

8. The cylindrical secondary battery according to claim 2, wherein the conductive leads are conductive leads of the positive electrode and conductive leads of the negative electrode.

9. The cylindrical secondary battery according to claim 3, wherein the conductive leads are conductive leads of the positive electrode and conductive leads of the negative electrode.

10. The cylindrical secondary battery according to claim 4, wherein the conductive leads are conductive leads of the positive electrode and conductive leads of the negative electrode.

11. The cylindrical secondary battery according to claim 5, wherein the conductive leads are conductive leads of the positive electrode and conductive leads of the negative electrode.

12. The cylindrical secondary battery according to claim 6, wherein the conductive leads are conductive leads of the positive electrode and conductive leads of the negative electrode.
